(19) United States
(12) Patent Application Publication
(10) Pub. No.: US 2023/0141941 A1
(43) Pub. Date: May 11, 2023

(54) METHOD AND APPARATUS FOR DETERMINING CONTROL RESOURCE SET

(71) Applicant: Lenovo (Beijing) Ltd., Beijing (CN)

(72) Inventors: Yuantao Zhang, Beijing (CN); Zhi Yan, Beijing (CN); Hongmei Liu, Beijing (CN); Haiming Wang, Beijing (CN)

(73) Assignee: Lenovo (Beijing) Ltd., Beijing (CN)

(21) Appl. No.: 17/915,966

(22) PCT Filed: Apr. 1, 2020
(86) PCT No.: PCT/CN2020/082833

§ 371 Date: Sep. 29, 2022

(51) Int. Cl. H04L 5/00

(52) U.S. Cl. CPC H04L 5/0053; H04L 5/0005

(57) ABSTRACT

The present application relates to a user equipment, a base station, and a method for determining control resource set. The base station transmits a configuration of a first control resource set to the user equipment. The user equipment receives the configuration of the first control resource set from the base station. The user equipment and the base station determine a second control resource set according to the first control resource set.

### TECHNICAL FIELD

The present disclosure generally relates to the determination of control resource set, and relates more particularly to the determination of control resource set for New Radio apparatus.

### BACKGROUND OF THE INVENTION

In conventional network, Physical Downlink Control Channel (PDCCH) detection may be performed between user equipment and base station according to some configurations of network resources. These configurations may include control resource set configuration, search space set configuration and demodulation reference symbol position.

For some networks which are compatible with New Radio (NR) protocol, NR apparatus with reduced capabilities (i.e., NR-Light apparatus) may be introduced. Because the capabilities of NR-Light apparatus may be limited, the configurations for performing PDCCH detection by NR-Light apparatus need to be re-configured. However, specific details of the configurations for the NR-Light apparatus to perform PDCCH detection have not been discussed yet and there are still some issues that need to be solved.

### BRIEF SUMMARY OF THE INVENTION

One embodiment of the present disclosure provides a method of a user equipment. The method includes: receiving a configuration of a first control resource set (CORESET) from a base station; and determining a second CORESET based on the first CORESET, wherein an initial physical resource block (PRB) of the second CORESET is allocated as an initial PRB of a control channel element (CCE) of the first CORESET.

Another embodiment of the present disclosure provides a method of a base station. The method includes: transmitting a configuration of a first CORESET to a user equipment; and determining a second CORESET based on the first CORESET, wherein an initial PRB of the second CORESET is allocated as an initial PRB of a CCE of the first CORESET.

Yet another embodiment of the present disclosure provides an apparatus. According to an embodiment of the present disclosure, the apparatus includes: at least one non-transitory computer-readable medium having computer executable instructions stored therein; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions are configured to, with the at least one processor, cause the apparatus to perform a method according to an embodiment of the present disclosure.

### BRIEF DESCRIPTION OF THE DRAWINGS

In order to describe the manner in which advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a wireless communication system according to an embodiment of the present disclosure.

FIG. 2A illustrates configuration transmission in a wireless communication system according to an embodiment of the present disclosure.

FIGS. 2B to 2I are schematic views of the CORESETs according to an embodiment of the present disclosure.

FIGS. 3A to 3B are schematic views of the CORESETs according to an embodiment of the present disclosure.

FIG. 4 is a schematic view of the CORESETs according to an embodiment of the present disclosure.

FIGS. 5A to 5B are schematic views of the CORESETs according to an embodiment of the present disclosure.

FIG. 6 is a schematic view of the CORESETs according to an embodiment of the present disclosure.

FIG. 7 is a schematic view of the CORESETs according to an embodiment of the present disclosure.

FIG. 8 illustrates flow chart of a method for wireless communications according to an embodiment of the present disclosure.

FIG. 9 illustrates an example block diagram of an apparatus according to an embodiment of the present disclosure.

### DETAILED DESCRIPTION OF THE INVENTION

The detailed description of the appended drawings is intended as a description of preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

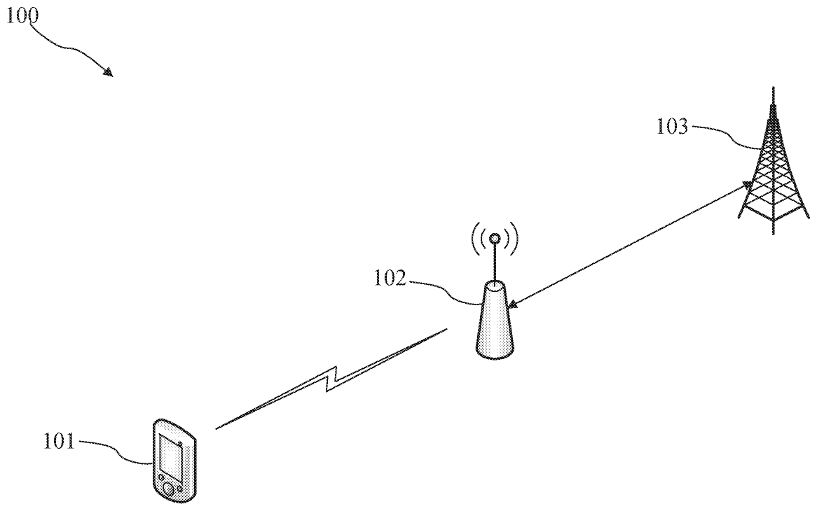

Referring to FIG. 1, a wireless communication system 100 may include a user equipment (UE) 101, a base station (BS) 102 and a core network (CN) 103. Although a specific number of UE 101, BS 102 and CN 103 are depicted in FIG. 1, it is contemplated that any number of UEs 101, BSs 102 and CNs 103 may be included in the wireless communication system 100.

CN 103 may include a core Access and Mobility management Function (AMF) entity. BS 102, which may communicate with CN 103, may operate or work under the control of the AMF entity. CN 103 may further include a User Plane Function (UPF) entity, which communicatively coupled with the AMF entity.

BS 102 may be distributed over a geographic region. In certain embodiments of the present application, BS 102 may also be referred to as an access point, an access terminal, a base, a base unit, a macro cell, a Node-B, an evolved Node B (eNB), a gNB, a Home Node-B, a relay node, or a device, or described using other terminology used in the art. BS 102 is generally part of a radio access network that may include one or more controllers communicably coupled to one or more corresponding BS(s).

UE 101 may include, for example, but is not limited to, computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), Internet of Thing (IoT) devices, or the like.

According to some embodiments of the present application, UE 101 may include, for example, but is not limited to, a portable wireless communication device, a smart phone, a cellular telephone, a flip phone, a device having a subscriber identity module, a personal computer, a selective call receiver, or any other device that is capable of sending and receiving communication signals on a wireless network.

In some embodiments of the present application, UE 101 may include, for example, but is not limited to, wearable devices, such as smart watches, fitness bands, optical head-mounted displays, or the like. Moreover, UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art. UE 101 may communicate directly with BS 102 via uplink communication signals.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, a Long Term Evolution (LTE) network, a 3GPP-based network, a 3GPP 5G network, a satellite communications network, a high altitude platform network, and/or other communications networks.

In some embodiments of the present application, the wireless communication system 100 is compatible with the 5G New Radio (NR) of the 3GPP protocol or the 5G NR-light of the 3GPP protocol, wherein BSs 102 transmit data using an OFDM modulation scheme on the downlink (DL) and UE 101 transmit data on the uplink (UL) using a single-carrier frequency division multiple access (SC-FDMA) or OFDM scheme. More generally, however, the wireless communication system 100 may implement some other open or proprietary communication protocols, for example, WiMAX, among other protocols.

In some embodiments of the present application, BS 102 may communicate using other communication protocols, such as the IEEE 802.11 family of wireless communication protocols. Further, in some embodiments of the present application, BS 102 may communicate over licensed spectrums, whereas in other embodiments BS 102 may communicate over unlicensed spectrums. The present application is not intended to be limited to the implementation of any particular wireless communication system architecture or protocol. In yet some embodiments of present application, BS 102 may communicate with UE 101 using the 3GPP 5G protocols.

According to some existed agreements, UE 101 and BS 102 included in the wireless communication system 100 may be compatible with NR-Light of the 3GPP protocol. However, because the capabilities of NR-Light UE 101 may be limited, the configurations for performing Physical Downlink Control Channel (PDCCH) detection by UE 101 and BS 102 need to be re-configured.

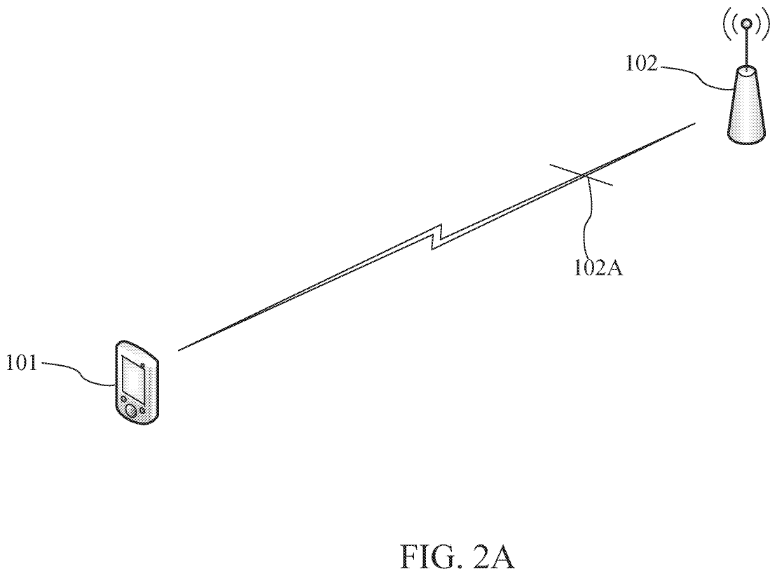

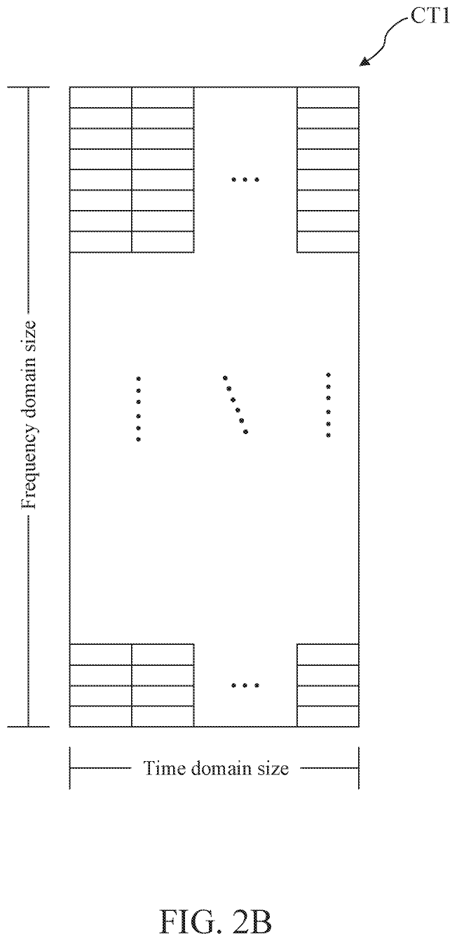

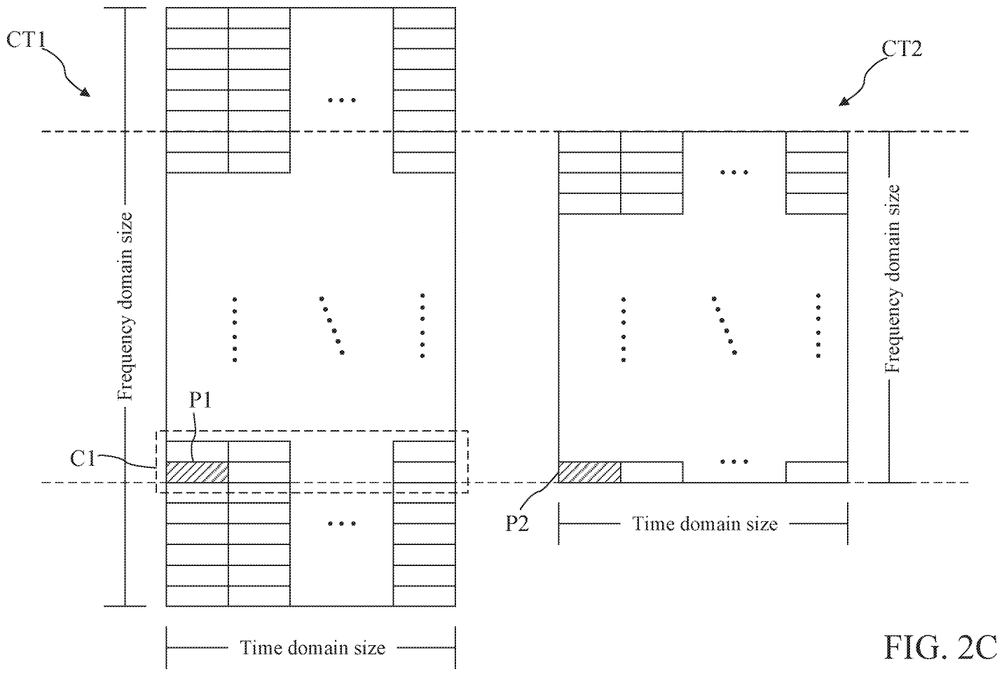

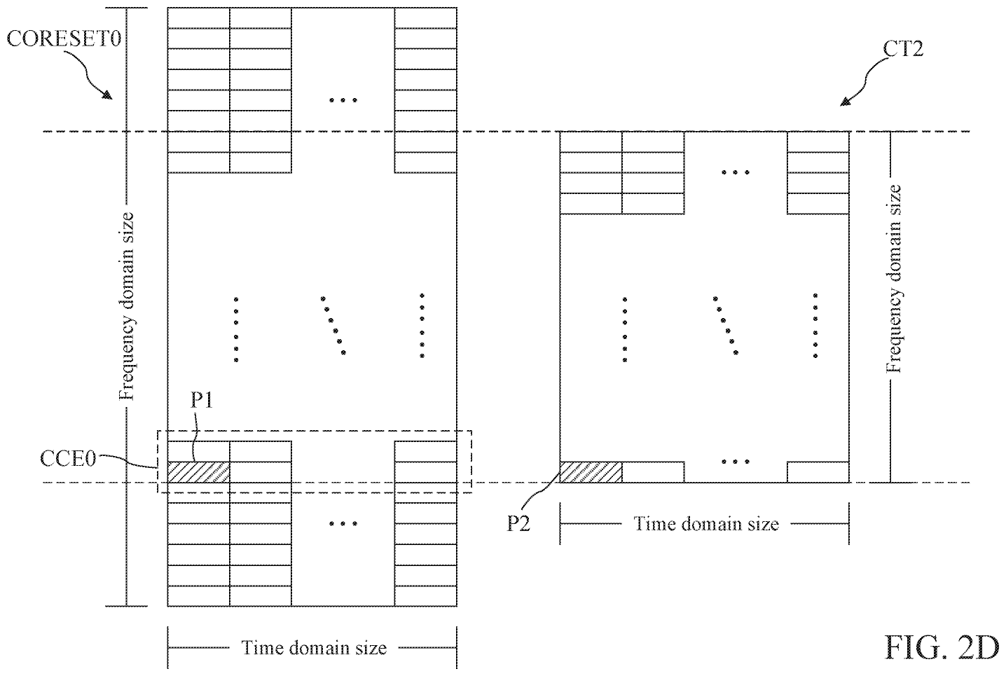

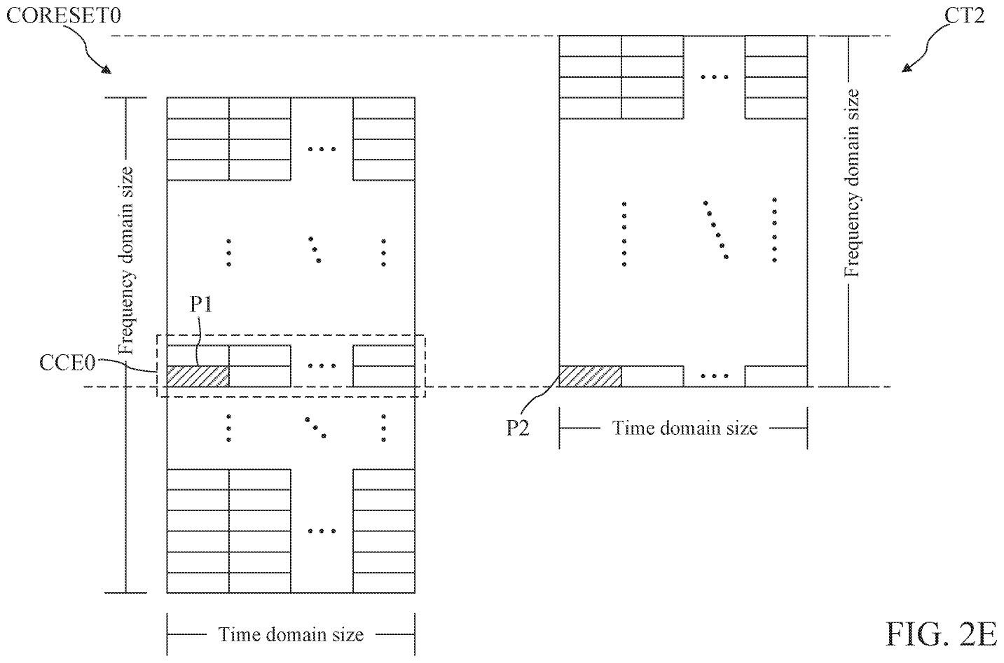

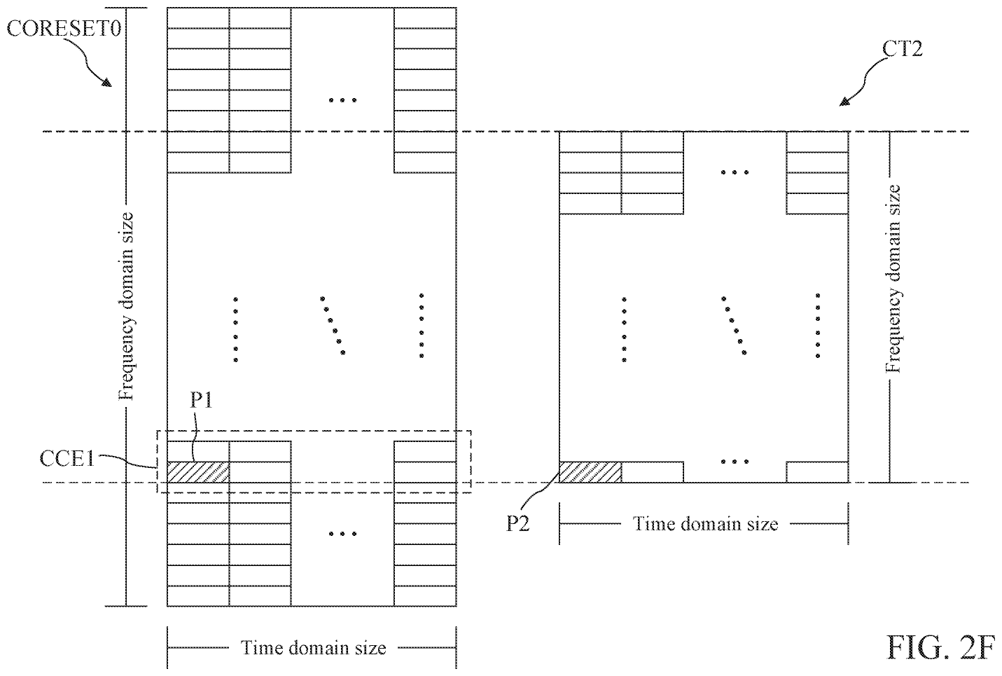

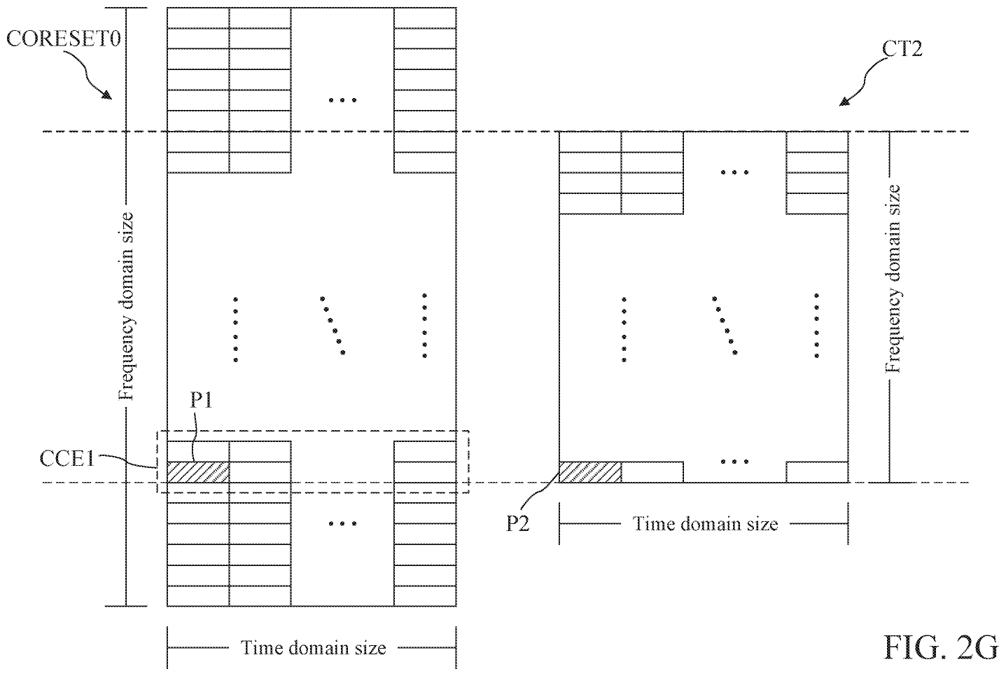

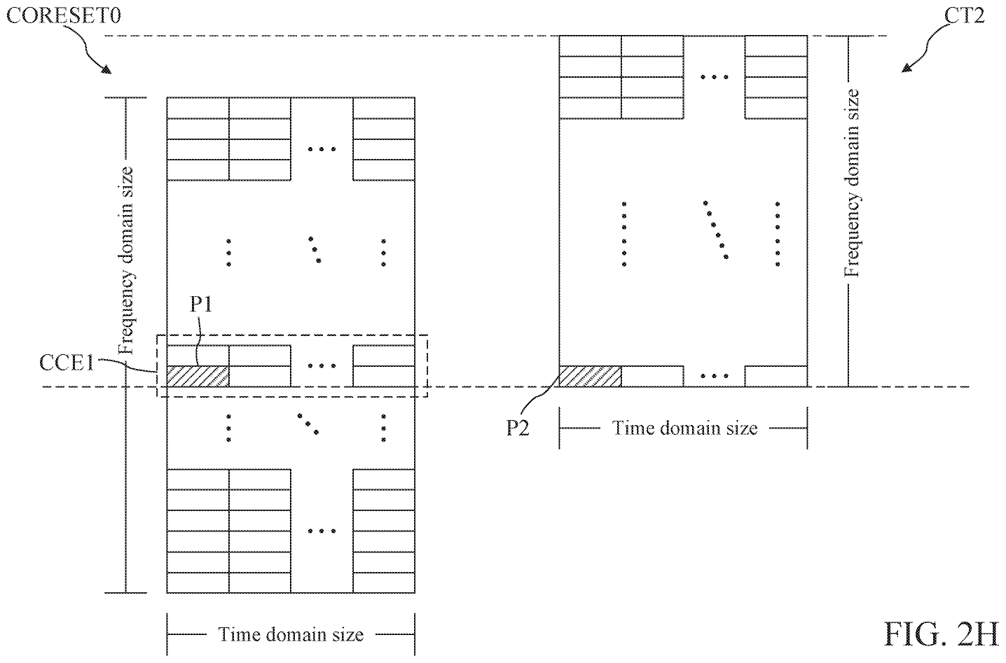

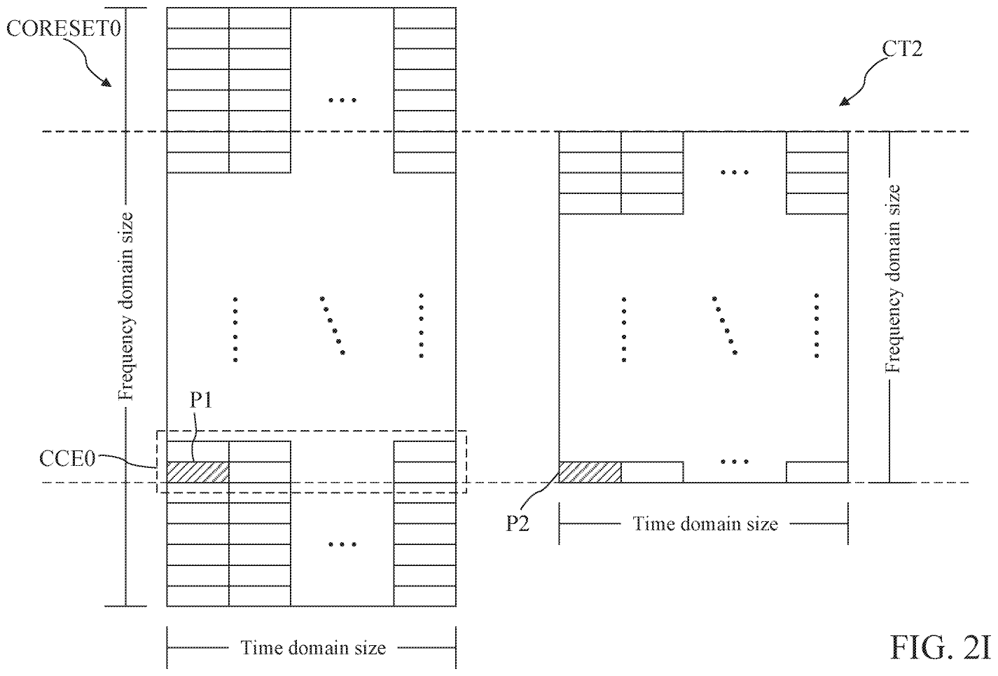

In some embodiments, a general configuration of control resource set (CORESET) may be used for UE 101 and BS 102 to determine another configuration of CORESET proper to NR-Light protocol. In detail, referring to FIG. 2A, BS 102 may broadcast master information block (MIB) 102A which may include a configuration of a first CORESET CT1. Then, UE 101 may receive the MIB 102A including the configuration of the first CORESET CT1 through detecting synchronization signal blocks (SSBs).

Next, UE 101 may retrieve the configuration of the first CORESET CT1 from the MIB 102A. UE 101 and BS 102 may then determine the first CORESET CT1 according to the configuration respectively. Specifically, please refer to FIG. 2B, the configuration of the first CORESET CT1 may include a frequency domain size and a time domain size for defining the first CORESET CT1.

In some implementations, the first CORESET CT1 may include a CORESET zero (i.e., CORESET0) specified in 3GPP Technical Specification #38.213 (the entirety of which are incorporated herein by reference), and the frequency domain size and the time domain size for defining the first CORESET CT1 may be selected from:
(1) 24 physical resource blocks (PRBs) for frequency domain and 2 Orthogonal Frequency Division Multiplexing (OFDM) symbols in time domain;
(2) 24 PRBs for frequency domain and 3 OFDM symbols in time domain;
(3) 48 PRBs for frequency domain and 1 OFDM symbols in time domain;
(4) 48 PRBs for frequency domain and 2 OFDM symbols in time domain;
(5) 48 PRBs for frequency domain and 3 OFDM symbols in time domain;
(6) 96 PRBs for frequency domain and 1 OFDM symbols in time domain;
(7) 96 PRBs for frequency domain and 2 OFDM symbols in time domain; or
(8) 96 PRBs for frequency domain and 3 OFDM symbols in time domain.

Please refer to FIG. 2C. After determining the first CORESET CT1 based on the selected frequency domain size and time domain size, UE 101/BS 102 may determine a second CORESET CT2 according to the first CORESET CT1. In detail, in frequency domain, UE 101/BS 102 may allocate an initial PRB P2 of the second CORESET CT2 as an initial PRB P1 of the first CORESET CT1. Particularly, the initial PRB P2 of the second CORESET CT2 may be allocated as the initial PRB P1 of a specific control channel element (CCE) C1 of the first CORESET CT1. In some implementations, when the first CORESET CT1 includes the CORESET0, the specific CCE C1 of the first CORESET CT1 may include CCE zero (CCE0) or CCE one (CCE1) of the CORESET0.

More specifically, when UE 101/BS102 determines that a pre-defined frequency domain size of the second CORESET CT2 is smaller than the frequency domain size of the first CORESET CT1, UE 101/BS102 then determines whether the initial PRB of the second CORESET CT2 should be allocated as the initial PRB of CCE0 of the CORESET0 or as the initial PRB of CCE1 of the CORESET0. It should be noted that the pre-defined frequency domain size of the second CORESET CT2 may be a default setting stored in UE 101/BS102 or the pre-defined frequency domain size of the second CORESET CT2 may be determined by BS 102 and included in the configuration of the first CORESET CT1. In some embodiments, the size of second CORESET CT2 in time domain and/or in frequency domain may be determined by the configuration of the first CORESET CT1.

Please refer to FIG. 2D. If frequency band of the second CORESET CT2 is determined within frequency band of the CORESET0 when the initial PRB P2 of the second CORESET CT2 is allocated as the initial PRB P1 of CCE0 of the CORESET0, UE 101/BS 102 determines that the initial PRB P2 of the second CORESET CT2 is allocated as the initial PRB P1 of CCE0 of the CORESET0.

Please refer to FIGS. 2E to 2F. As shown in FIG. 2E, if frequency band of the second CORESET CT2 is determined not within (e.g., partially overlapped) frequency band of the CORESET0 when an initial PRB P2 of the second CORESET CT2 is allocated as the initial PRB P1 of CCE0 of the CORESET0, UE 101/BS 102 determines that the initial PRB P2 of the second CORESET CT2 is allocated as an initial PRB P1 of CCE1 of the CORESET0 as shown in FIG. 2F.

Please refer to FIG. 2G. Similarly, if frequency band of the second CORESET CT2 is determined within frequency band of the CORESET0 when an initial PRB P2 of the second CORESET CT2 is allocated as an initial PRB P1 of CCE1 of the CORESET0, UE 101/BS 102 determines that the initial PRB P2 of the second CORESET CT2 is allocated as the initial PRB P1 of CCE1 of the CORESET0.

Please refer to FIGS. 2H to 2I. As shown in FIG. 2H, if frequency band of the second CORESET CT2 is determined not within (e.g., partially overlapped) frequency band of the CORESET0 when the initial PRB P2 of the second CORESET CT2 is allocated as the initial PRB P1 of CCE1 of the CORESET0, UE 101/BS 102 determines that the initial PRB P2 of the second CORESET CT2 is allocated as an initial PRB P1 of CCE0 of the CORESET0 as shown in FIG. 2I.

Further, in time domain, UE 101/BS 102 may determine at least one resource unit for the second CORESET CT2 according to a pre-defined time domain size. It should be noted that the pre-defined time domain size of the second CORESET CT2 may be a default setting stored in UE 101/BS 102 or the pre-defined time domain size of the second CORESET CT2 may be determined by BS 102 and included in the configuration of the first CORESET CT1.

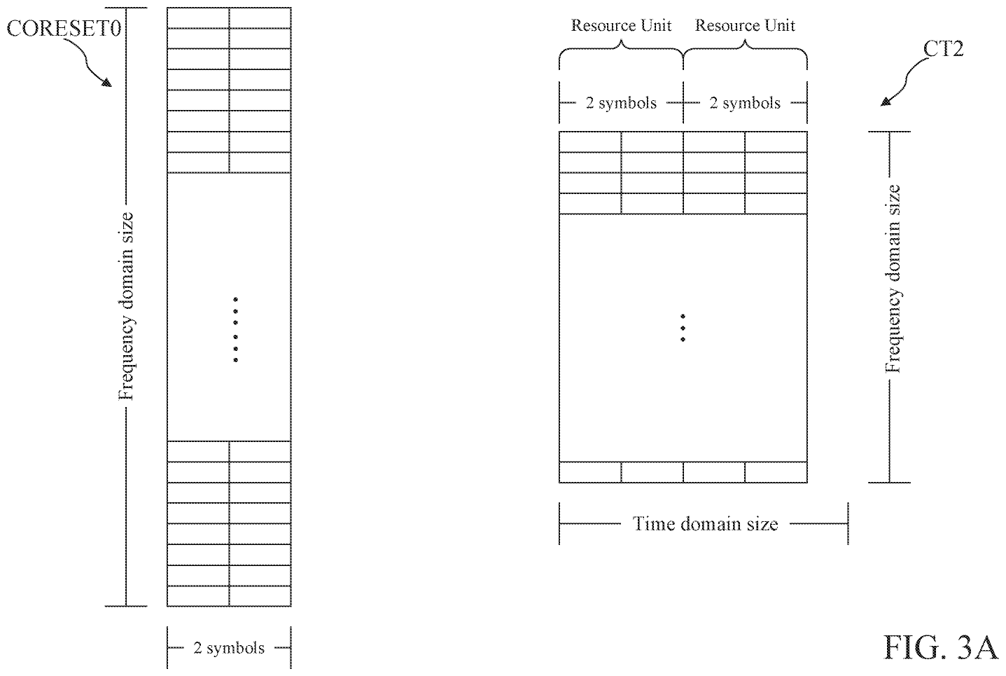

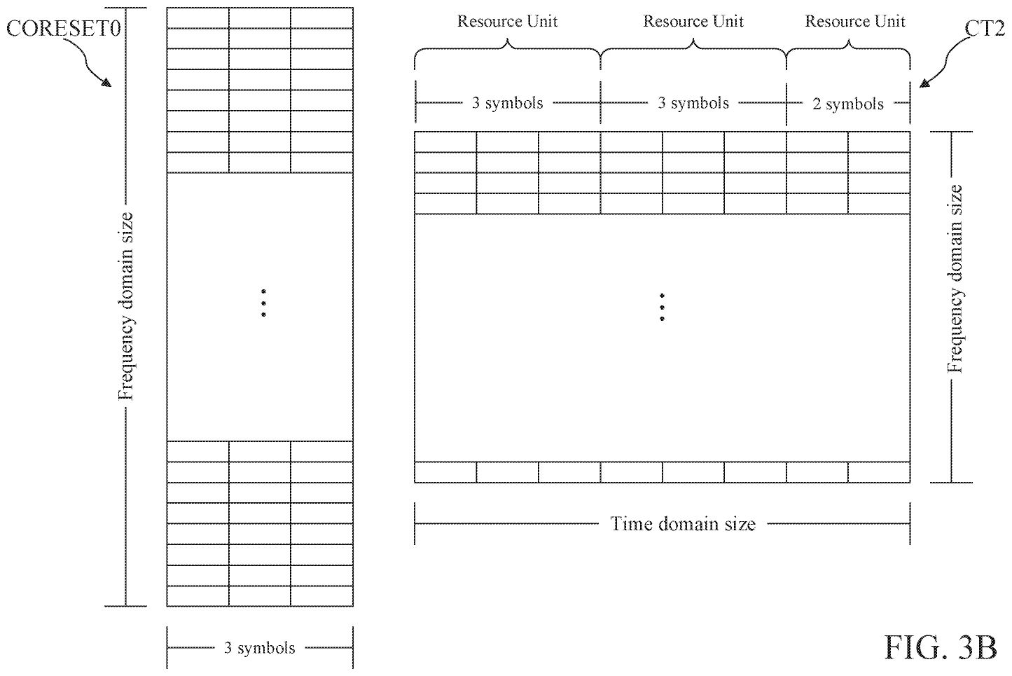

In some implementations, each resource unit of the second CORESET CT2 may include at least one OFDM symbol(s). The number of the OFDM symbol(s) of each resource unit may be same as the number of the OFDM symbol(s) of the first CORESET CT1. For example, please refer to FIG. 3A, when the first CORESET CT1 includes the CORESET0 and the time domain size is selected as 2 OFDM symbols, the number of the OFDM symbols of each resource unit is configured as 2 OFDM symbols.

In some implementations, each of first “N−1” resource units of the second CORESET CT2 may include at least one OFDM symbol(s), and the number of the OFDM symbol(s) of each of first “N−1” resource units may be same as the number of the OFDM symbol(s) of the first CORESET CT1. The Nₜₕ resource unit of the second CORESET CT2 may include at least one OFDM symbol(s), and the number of the OFDM symbol(s) of the Nₜₕ resource unit may be configured as less than the number of the OFDM symbol(s) of the first CORESET CT1.

For example, please refer to FIG. 3B, when the first CORESET CT1 includes the CORESET0, the time domain size is selected as 3 OFDM symbols and the second CORESET CT2 includes 3 resource units, the number of the OFDM symbols of each of the first two (i.e., “3−1=2”) resource units is configured as 3 OFDM symbols. The number of the OFDM symbols of the third resource unit is configured less than 3 OFDM symbols (e.g., 2 OFDM symbols).

In some embodiments, in the resource units of the second CORESET CT2 that have same time domain duration (i.e., include same number of OFDM symbols) of the first CORESET CT1, a resource element group bundle (REGB) may include a plurality of resource element groups (REGs). In some implementations, the number of the REGs in one REGB of the second CORESET CT2 may be same as the number of REGs in one REGB of the first CORESET CT1. For example, when the first CORESET CT1 includes the CORESET0 and one REGB of CORESET0 includes six REGs, the number of the REGs in one REGB of the second CORESET CT2 is also six.

In some embodiments, the REGB of the second CORESET CT2 may be: (1) sequentially indexed in each resource unit; and (2) sequentially indexed from one resource unit to another resource unit.

In some implementations of that the number of the OFDM symbols of each resource unit is configured as the same as the number of the OFDM symbols of the first CORESET CT1, the indexes of the REGB of the second CORESET CT2 may be configured as the following rule:
REGBs of resource unit “x” is indexed as: REGB{x*N_RegBundle_unit, x*N_RegBundle_unit+1, . . . , x*N_RegBundle_unit+N_RegBundle_unit−1}, wherein N_RegBundle_unit represents the number of REGBs per resource unit.

For example, when there are two resource unit “0” and “1” in the second CORESET CT2 and N_RegBundle_unit is 8:
REGBs of resource unit “0” are indexed as: REGB(0*8), REGB(0*8+1), REGB(0*8+2), REGB(0*8+3), REGB(0*8+4), REGB(0*8+5), REGB(0*8+6) and REGB(0*8+7), i.e., the REGBs of resource unit “0” are indexed as: REGB0, REGB1, REGB2, REGB3, REGB4, REGB5, REGB6 and REGB7; and
REGBs of resource unit “1” are indexed as: REGB(1*8), REGB(1*8+1), REGB(1*8+2), REGB(1*8+3), REGB(1*8+4), REGB(1*8+5), REGB(1*8+6) and REGB(1*8+7), i.e., the REGBs of resource unit “1” are indexed as: REGB8, REGB9, REGB10, REGB11, REGB12, REGB13, REGB14 and REGB15.

In some implementations of that: (1) the number of the OFDM symbols of each of first “N−1” resource units is configured as the same as the number of the OFDM symbols of the first CORESET CT1; and (2) the number of the OFDM symbols of the Nₜₕ resource unit is configured as less than the number of the OFDM symbols of the first CORESET CT1, the indexes of the REGB of the second CORESET CT2 may be configured as following rules:
REGBs of first N−1 resource units “x” is indexed as: REGB {x*N_RegBundle_unit, x*N_RegBundle_unit+1, . . . , x*N_RegBundle_unit+N_RegBundle_unit−1}, wherein N_RegBundle_unit represents the number of REGBs per resource unit; and
REGBs of Nₜₕ resource unit “y” is indexed as: {y*N_RegBundle_unit+N_RegBundle_unit, y*N_RegBundle_unit+N_RegBundle_unit+1, . . . , N_RegBundle}, wherein N_RegBundle represents the number of REGBs of the second CORESET CT2.

For example, when there are three resource unit “0”, “1” and “2” in the second CORESET CT2, N_RegBundle_unit is 8 and N_RegBundle is 20:
REGBs of resource unit “0” are indexed as: REGB(0*8), REGB(0*8+1), REGB(0*8+2), REGB(0*8+3), REGB(0*8+4), REGB(0*8+5), REGB(0*8+6) and REGB(0*8+7), i.e., the REGBs of resource unit “0” are indexed as: REGB0, REGB1, REGB2, REGB3, REGB4, REGB5, REGB6 and REGB7;
REGBs of resource unit “1” are indexed as: REGB(1*8), REGB(1*8+1), REGB(1*8+2), REGB(1*8+3), REGB(1*8+4), REGB(1*8+5), REGB(1*8+6) and REGB(1*8+7), i.e., the REGBs of resource unit “1” are indexed as: REGB8, REGB9, REGB10, REGB11, REGB12, REGB13, REGB14 and REGB15; and
REGBs of resource unit “2” are indexed as: REGB(2*8), REGB(2*8+1), REGB(2*8+2) and REGB(2*8+3), i.e., the REGBs of resource unit “2” are indexed as: REGB16, REGB17, REGB18 and REGB19.

In some embodiments, when the first CORESET CT1 includes the CORESET0, a mapping relation of CCE-to-REGB of the first CORESET CT1 may be defined as the following rules:
CCE0 of CORESET0 maps to REGB“X” while X=n_{shift} mod (N_{REG}^{CORESET}/L), wherein n_{shift} represents an offset, N_{REG}^{CORESET} represents the number of REGs of the CORESET0 and L represents the number of REGs in one REGB;
When the number of REGBs of the CORESET0 is K and an interleaver size is R:
   CCE“R*i” maps to REGB“X+i”, i=0,1,2, . . . ,(K/2)−1, wherein if “X+i” is greater than “K−1”, then CCE numbering is continued in a wraparound way from REGB0;
   CCE“R*i+1” maps to REGB“X+i+K/2”, i=0,1,2, . . . , (K/2)−1, wherein if “X+i+K/2” is greater than “K−1”, then CCE numbering is continued in a wraparound way from REGB0.

In some embodiments, when frequency band of the first CORESET CT1 is greater than frequency band of the second CORESET CT2, a mapping relation of CCE-to-REG of the second CORESE CT2 may be re-defined. In detail, when the first CORESET CT1 includes the CORESET0 and the initial PRB of the second CORESET CT2 is allocated as the initial PRB of CCE0 of the CORESET0, a mapping relation of CCE-to-REG of the second CORESET CT2 may be defined as the following rules
CCE0 of CORESET0 maps to REGB“X” while X=n_{shift} mod (N_{REG}^{CORESET}/L), wherein n_{shift}=0, and N_{REG}^{CORESET} represents the number of REGs of the CORESET0 and L represents the number of REGs in one REGB;
When the number of REGBs of the CORESET0 is K and an interleaver size is R:
   CCE“R*i” maps to REGB“X+i”, i=0,1,2, . . . ,(K/2)−1, wherein if “X+i” is greater than “K−1”, then CCE numbering is continued in a wraparound way from REGB0;
   CCE“R*i+1” maps to REGB“X+i+K/2”, i=0,1,2, . . . , (K/2)−1, wherein if “X+i+K/2” is greater than “K−1”, then CCE numbering is continued in a wraparound way from REGB0.

When the first CORESET CT1 includes the CORESET0 and the initial PRB of the second CORESET CT2 is allocated as the initial PRB of CCE1 of the CORESET0, a mapping relation of CCE-to-REG of the second CORESET CT2 may be defined as the following rules
CCE0 of CORESET0 maps to REGB“X” while X=n_{shift} mod (N_{REG}^{CORESET}/L), wherein n_{shift}=N_RegBundle/2, and N_RegBundle represents the number of REGBs of the CORESET0, N_{REG}^{CORESET} represents the number of REGs of the CORESET0 and L represents the number of REGs in one REGB;
When the number of REGBs of the CORESET0 is K and an interleaver size is R:
   CCE“R*i” maps to REGB“X+i”, i=0,1,2, . . . ,(K/2)−1, wherein if “X+i” is greater than “K−1”, then CCE numbering is continued in a wraparound way from REGB0;
   CCE“R*i+1” maps to REGB“X+i+K/2”, i=0,1,2, . . . , (K/2)−1, wherein if “X+i+K/2” is greater than “K−1”, then CCE numbering is continued in a wraparound way from REGB0.

In some embodiments, BS 102 may transmit the configuration of the first CORESET CT1 further with a first search space set. The first search space set corresponds to a first set of aggregation levels. In some implementations, when the first CORESET CT1 includes the CORESET0, the configuration of the first CORESET CT1 may be associated with search space zero specified in 3GPP Technical Specification #38.213 and the first set of aggregation levels may include aggregation level 4, 8 and 16 which correspond to number of CCE candidates 4, 2 and 1 respectively.

Next, UE 101 may receive the configuration of the first CORESET CT1 and the first search space set. UE 101/BS 102 may determine a second set of aggregation levels for a second search space set of the second CORESET CT2. In some implementations, the aggregation levels in the second set may be equal to or higher than those in the first set of aggregation levels.

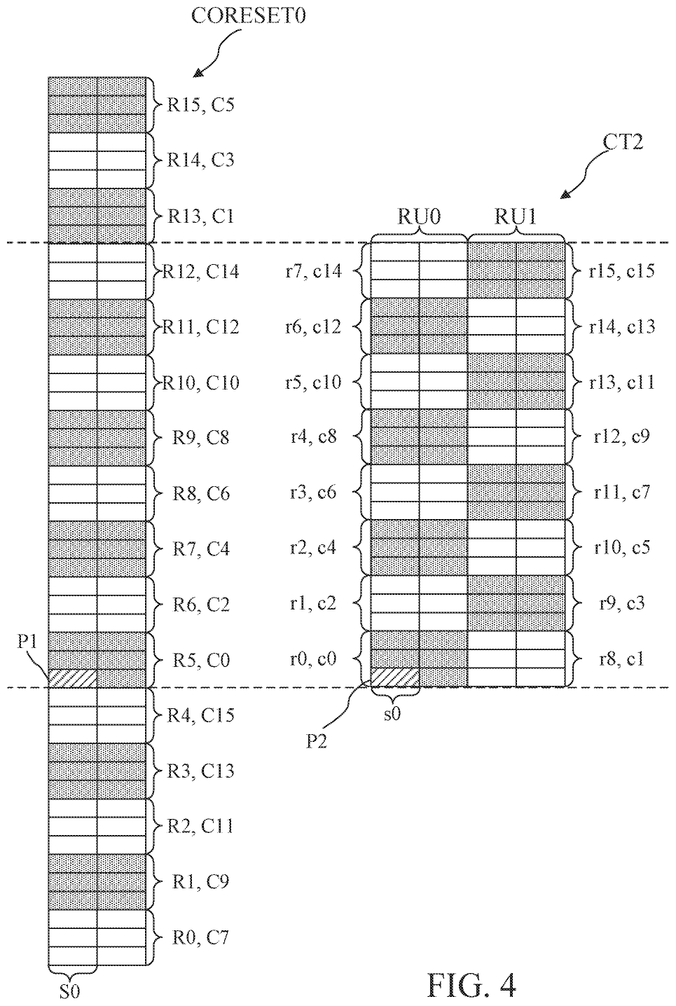

Please refer to FIG. 4 for some implementations of determining the second CORESET CT2 based on the first CORESET CT1 including the CORESET0. In detail, after UE 101 receives MIB information including a configuration of the CORESET0 from BS 102, UE 101 can retrieve the following information from the configuration: (1) the frequency domain size of the CORESET0 includes 48 PRBs; and (2) the time domain size of the CORESET0 includes 2 OFDM symbols. Then, UE 101/BS 102 respectively determines the second CORESET CT2 according to: (1) the configuration of CORESET0; (2) a pre-defined frequency domain size, which includes 24 PRBs, of the second CORESET CT2; and (3) a pre-defined time domain size, which includes 4 OFDM symbols of 2 resource units, of the second CORESET CT2.

Particularly, as for the CORESET0 of these implementations, n_{shift} is configured as 5, N_{REG}^{CORESET} is configured as 48*2=96 and L is configured as 6, i.e., one REGB contains 6 REGs, as shown in FIG. 4. Therefore, CCE0 of the CORESET0 maps to REGB5. Further, the mapping relation of CCE-to-REG of the CORESET0 is defined as:
CCE0 (C0 as shown in FIG. 4) maps to REGB5 (R5 as shown in FIG. 4)
CCE2 (C2 as shown in FIG. 4) maps to REGB6 (R6 as shown in FIG. 4)
CCE4 (C4 as shown in FIG. 4) maps to REGB7 (R7 as shown in FIG. 4)
CCE6 (C6 as shown in FIG. 4) maps to REGB8 (R8 as shown in FIG. 4)
CCE8 (C8 as shown in FIG. 4) maps to REGB9 (R9 as shown in FIG. 4)
CCE10 (C10 as shown in FIG. 4) maps to REGB10 (R10 as shown in FIG. 4)
CCE12 (C12 as shown in FIG. 4) maps to REGB11 (R11 as shown in FIG. 4)
CCE14 (C14 as shown in FIG. 4) maps to REGB12 (R12 as shown in FIG. 4)
CCE1 (C1 as shown in FIG. 4) maps to REGB13 (R13 as shown in FIG. 4)
CCE3 (C3 as shown in FIG. 4) maps to REGB14 (R14 as shown in FIG. 4)
CCE5 (C5 as shown in FIG. 4) maps to REGB15 (R15 as shown in FIG. 4)
CCE7 (C7 as shown in FIG. 4) maps to REGB0 (R0 as shown in FIG. 4)
CCE9 (C9 as shown in FIG. 4) maps to REGB1 (R1 as shown in FIG. 4)
CCE11 (C11 as shown in FIG. 4) maps to REGB2 (R2 as shown in FIG. 4)
CCE13 (C13 as shown in FIG. 4) maps to REGB3 (R3 as shown in FIG. 4)
CCE15 (C15 as shown in FIG. 4) maps to REGB4 (R4 as shown in FIG. 4)

Accordingly, as for the second CORESET CT2: (1) in time domain, UE 101/BS 102 determines that a first OFDM symbol s0 of the second CORESET CT2 starts from a first OFDM symbol S0 of the CORESET0; and (2) in frequency domain, because frequency band of the second CORESET CT2 is within frequency band of the CORESET0 when the initial PRB P2 of the second CORESET CT2 is allocated as an initial PRB P1 of CCE0 of the CORESET0, UE 101/BS 102 determines that the initial PRB P2 of the second CORESET CT2 is allocated as the initial PRB P1 of CCE0 of the CORESET0.

Further, the second CORESET CT2 includes two resource units RU0 and RU1. The number of OFDM symbols of each resource unit is the same as the number of OFDM symbols of the CORESET0, which is 2 in these implementations. Each resource unit includes 8 REGBs. Therefore, resource units RU0 and RU1 include 16 REGBs. The REGBs of the second CORESET CT2 are: (1) sequentially indexed in each resource unit; and (2) sequentially indexed from one resource unit to another resource unit. Accordingly, 16 REGBs are indexed as REGB0 to REGB15 as shown in FIG. 4 (i.e., r0 to r15 as shown in FIG. 4).

Next, because the initial PRB P2 of the second CORESET CT2 is allocated as the initial PRB P1 of CCE0 of the CORESET0, n_{shift} is configured as 0. Therefore, a mapping relation of CCE-to-REG of the second CORESET CT2 is defined as:
CCE0 (c0 as shown in FIG. 4) maps to REGB0 (r0 as shown in FIG. 4)
CCE2 (c2 as shown in FIG. 4) maps to REGB1 (r1 as shown in FIG. 4)
CCE4 (c4 as shown in FIG. 4) maps to REGB2 (r2 as shown in FIG. 4)
CCE6 (c6 as shown in FIG. 4) maps to REGB3 (r3 as shown in FIG. 4)
CCE8 (c8 as shown in FIG. 4) maps to REGB4 (r4 as shown in FIG. 4)
CCE10 (c10 as shown in FIG. 4) maps to REGB5 (r5 as shown in FIG. 4)
CCE12 (c12 as shown in FIG. 4) maps to REGB6 (r6 as shown in FIG. 4)
CCE14 (c14 as shown in FIG. 4) maps to REGB7 (r7 as shown in FIG. 4)
CCE1 (c1 as shown in FIG. 4) maps to REGB8 (r8 as shown in FIG. 4)
CCE3 (c3 as shown in FIG. 4) maps to REGB9 (r9 as shown in FIG. 4)
CCE5 (c5 as shown in FIG. 4) maps to REGB10 (r10 as shown in FIG. 4)
CCE7 (c7 as shown in FIG. 4) maps to REGB11 (r11 as shown in FIG. 4)
CCE9 (c9 as shown in FIG. 4) maps to REGB12 (r12 as shown in FIG. 4)
CCE11 (c11 as shown in FIG. 4) maps to REGB13 (r13 as shown in FIG. 4)
CCE13 (c13 as shown in FIG. 4) maps to REGB14 (r14 as shown in FIG. 4)
CCE15 (c15 as shown in FIG. 4) maps to REGB15 (r15 as shown in FIG. 4)

In these implementations, a first search space set corresponding to a first set of aggregation levels is designated to the CORESET0. In detail, because the CORESET0 includes 16 REGBs, the first aggregation level set supports aggregation level 16 at most (i.e., the first aggregation level set supports aggregation level 4, 8 and 16). Accordingly, since the aggregation levels in a second aggregation level set should be equal to or higher than those in the first aggregation level set, UE 101 determines the maximum aggregation level as 16 for a second search space set of the second CORESET CT2. The CCE indices for each candidate of each aggregation level of the second aggregation level set are listed in the following table:

| | CCE indices | CCE indices | CCE indices | CCE indices |
|---|---|---|---|---|
| Aggregation | of 1^{st} | of 2^{nd} | of 3^{rd} | of 4^{th} |
| Level | candidate | candidate | candidate | candidate |
| 4 | 0, 1, 2, | 4, 5, 6, | 8, 9, 10, | 12, 13, 14, |
| | 3 | 7 | 11 | 15 |
| 8 | 0, 1, 2, | 8, 9, 10, | null | null |
| | 3, 4, 5, | 11, 12, 13, | | |
| | 6, 7 | 14, 15 | | |
| 16 | 0, 1, 2, | null | null | null |
| | 3, 4, 5, 6, | | | |
| | 7, 8, 9, 10, | | | |
| | 11, 12, 13, 14, | | | |
| | 15 | | | |

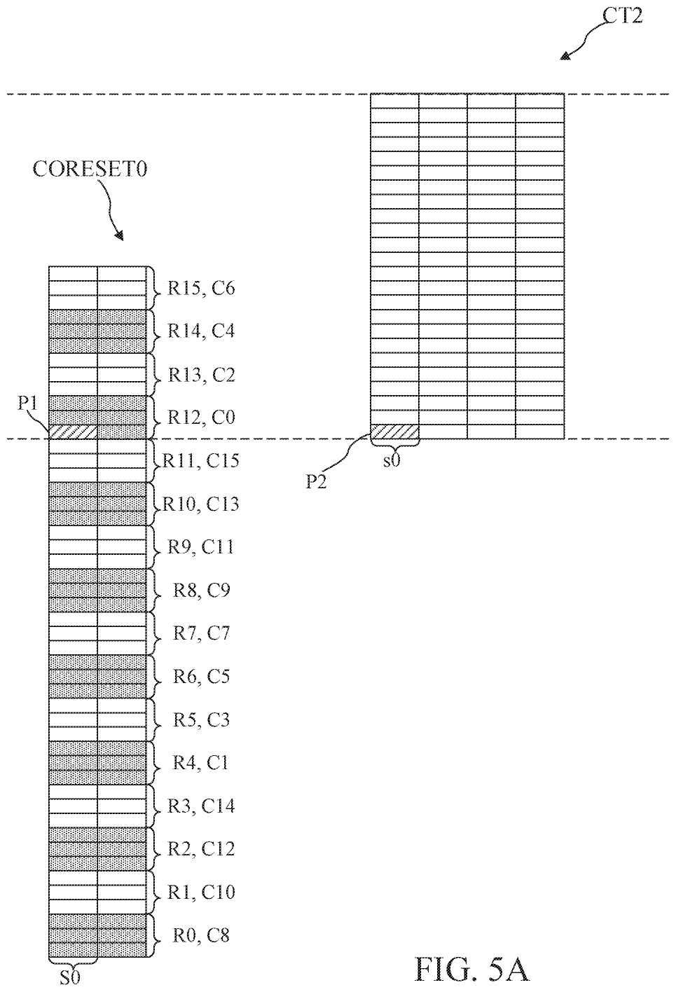

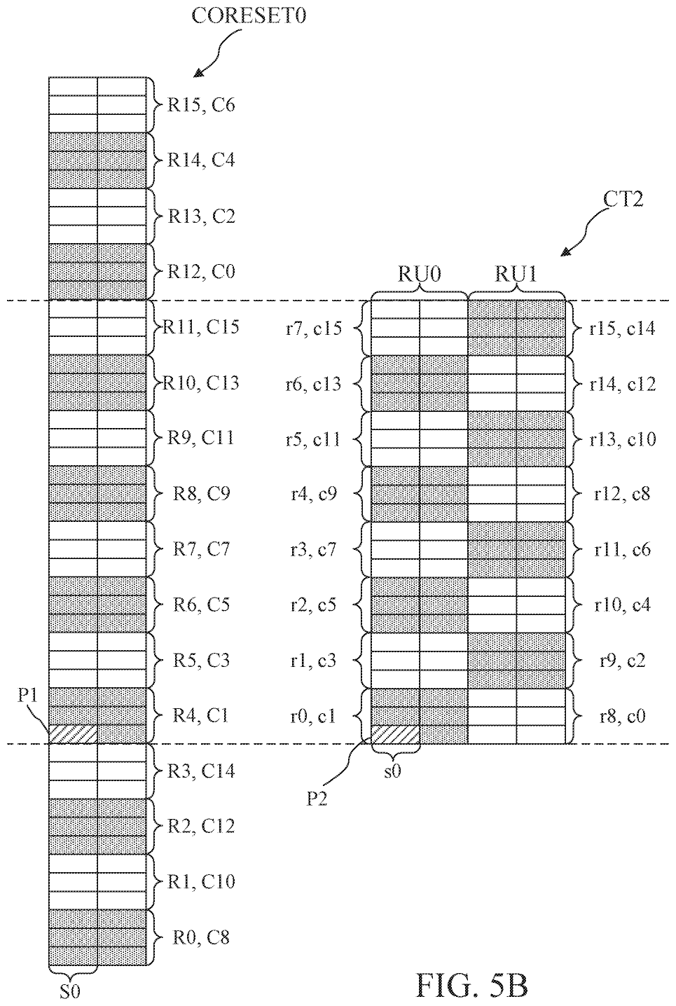

Please refer to FIG. 5A for some implementations of determining the second CORESET CT2 based on the first CORESET CT1 including the CORESET0. In detail, after UE 101 receives MIB information including a configuration of the CORESET0 from BS 102, UE 101 can retrieve the following information from the configuration: (1) the frequency domain size of the CORESET0 includes 48 PRBs; and (2) the time domain size of the CORESET0 includes 2 OFDM symbols. Then, UE 101/BS 102 respectively determines the second CORESET CT2 according to: (1) the configuration of CORESET0; (2) a pre-defined frequency domain size, which includes 24 PRBs, of the second CORESET CT2; and (3) a pre-defined time domain size, which includes 4 OFDM symbols of 2 resource units, of the second CORESET

Particularly, as for the CORESET0 of these implementations, n_{shift} is configured as 12, N_{REG}^{CORESET} is configured as 48*2=96 and L is configured as 6. Therefore, CCE0 of the CORESET0 maps to REGB12. Further, the mapping relation of CCE-to-REG of the CORESET0 is defined as:
CCE0 (C0 as shown in FIG. 5A) maps to REGB12 (R12 as shown in FIG. 5A)
CCE2 (C2 as shown in FIG. 5A) maps to REGB13 (R13 as shown in FIG. 5A)
CCE4 (C4 as shown in FIG. 5A) maps to REGB14 (R14 as shown in FIG. 5A)
CCE6 (C6 as shown in FIG. 5A) maps to REGB15 (R15 as shown in FIG. 5A)
CCE8 (C8 as shown in FIG. 5A) maps to REGB0 (R0 as shown in FIG. 5A)
CCE10 (C10 as shown in FIG. 5A) maps to REGB1 (R1 as shown in FIG. 5A)
CCE12 (C12 as shown in FIG. 5A) maps to REGB2 (R2 as shown in FIG. 5A)
CCE14 (C14 as shown in FIG. 5A) maps to REGB3 (R3 as shown in FIG. 5A)
CCE1 (C1 as shown in FIG. 5A) maps to REGB4 (R4 as shown in FIG. 5A)
CCE3 (C3 as shown in FIG. 5A) maps to REGB5 (R5 as shown in FIG. 5A)
CCE5 (C5 as shown in FIG. 5A) maps to REGB6 (R6 as shown in FIG. 5A)
CCE7 (C7 as shown in FIG. 5A) maps to REGB7 (R7 as shown in FIG. 5A)
CCE9 (C9 as shown in FIG. 5A) maps to REGB8 (R8 as shown in FIG. 5A)
CCE11 (C11 as shown in FIG. 5A) maps to REGB9 (R9 as shown in FIG. 5A)
CCE13 (C13 as shown in FIG. 5A) maps to REGB10 (R10 as shown in FIG. 5A)
CCE15 (C15 as shown in FIG. 5A) maps to REGB11 (R11 as shown in FIG. 5A)

Accordingly, as for the second CORESET CT2: (1) in time domain, UE 101 determines that a first OFDM symbol s0 of the second CORESET CT2 starts from a first OFDM symbol S0 of the CORESET0; and (2) in frequency domain, because frequency band of the second CORESET CT2 is not within (i.e., partially overlapped) frequency band of the CORESET0 when the initial PRB P2 of the second CORESET CT2 is allocated as an initial PRB P1 of CCE0 of the CORESET0, UE 101 determines that the initial PRB P2 of the second CORESET CT2 is allocated as an initial PRB P1 of CCE1 of the CORESET0 as shown in FIG. 5B.

Further, the second CORESET CT2 includes two resource units RU0 and RU1. The number of OFDM symbols of each resource unit is the same as the number of OFDM symbols of the CORESET0, which is 2 in these implementations. Each resource unit includes 8 REGBs. Therefore, resource units RU0 and RU1 include 16 REGBs. The REGBs of the second CORESET CT2 are: (1) sequentially indexed in each resource unit; and (2) sequentially indexed from one resource unit to another resource unit. Accordingly, 16 REGBs are indexed as REGB0 to REGB15 as shown in FIG. 5B (r0 to r15 as shown in FIG. 5B).

Next, because the initial PRB P2 of the second CORESET CT2 is allocated as the initial PRB P1 of CCE1 of the CORESET0, n_{shift} is configured as N_RegBundle/2 which is 16/2=8. Therefore, a mapping relation of CCE-to-REG of the second CORESET CT2 is defined as:
CCE1 (c1 as shown in FIG. 5B) maps to REGB0 (r0 as shown in FIG. 5B)
CCE3 (c3 as shown in FIG. 5B) maps to REGB1 (r1 as shown in FIG. 5B)
CCE5 (c5 as shown in FIG. 5B) maps to REGB2 (r2 as shown in FIG. 5B)
CCE7 (c7 as shown in FIG. 5B) maps to REGB3 (r3 as shown in FIG. 5B)
CCE9 (c9 as shown in FIG. 5B) maps to REGB4 (r4 as shown in FIG. 5B)
CCE11 (c11 as shown in FIG. 5B) maps to REGB5 (r5 as shown in FIG. 5B)
CCE13 (c13 as shown in FIG. 5B) maps to REGB6 (r6 as shown in FIG. 5B)
CCE15 (c15 as shown in FIG. 5B) maps to REGB7 (r7 as shown in FIG. 5B)
CCE0 (c0 as shown in FIG. 5B) maps to REGB8 (r8 as shown in FIG. 5B)
CCE2 (c2 as shown in FIG. 5B) maps to REGB9 (r9 as shown in FIG. 5B)
CCE4 (c4 as shown in FIG. 5B) maps to REGB10 (r10 as shown in FIG. 5B)
CCE6 (c6 as shown in FIG. 5B) maps to REGB11 (r11 as shown in FIG. 5B)
CCE8 (c8 as shown in FIG. 5B) maps to REGB12 (r12 as shown in FIG. 5B)
CCE10 (c10 as shown in FIG. 5B) maps to REGB13 (r13 as shown in FIG. 5B)
CCE12 (c12 as shown in FIG. 5B) maps to REGB14 (r14 as shown in FIG. 5B)
CCE14 (c14 as shown in FIG. 5B) maps to REGB15 (r15 as shown in FIG. 5B)

In these implementations, a first search space set corresponding to a first set of aggregation levels is designated to the CORESET0. In detail, because the CORESET0 includes 16 REGBs, the first aggregation level set supports aggregation level 16 at most (i.e., the first aggregation level supports aggregation level 4, 8 and 16). Accordingly, since the aggregation levels in a second aggregation level should be equal to or higher than those in the first aggregation level set, UE 101 determines the maximum aggregation level as 16 for a second search space set of the second CORESET CT2. The CCE indices for each candidate of each aggregation level of the second aggregation level are listed in the following table:

| | CCE indices | CCE indices | CCE indices | CCE indices |
|---|---|---|---|---|
| Aggregation | of 1^{st} | of 2^{nd} | of 3^{rd} | of 4^{th} |
| Level | candidate | candidate | candidate | candidate |
| 4 | 0, 1, 2, | 4, 5, 6, | 8, 9, 10, | 12, 13, 14, |
| | 3 | 7 | 11 | 15 |
| 8 | 0, 1, 2, | 8, 9, 10, | null | null |
| | 3, 4, 5, | 11, 12, 13, | | |
| | 6, 7 | 14, 15 | | |
| 16 | 0, 1, 2, | null | null | null |
| | 3, 4, 5, | | | |
| | 6, 7, 8, | | | |
| | 9, 10, 11, | | | |
| | 12, 13, 14, 15 | | | |

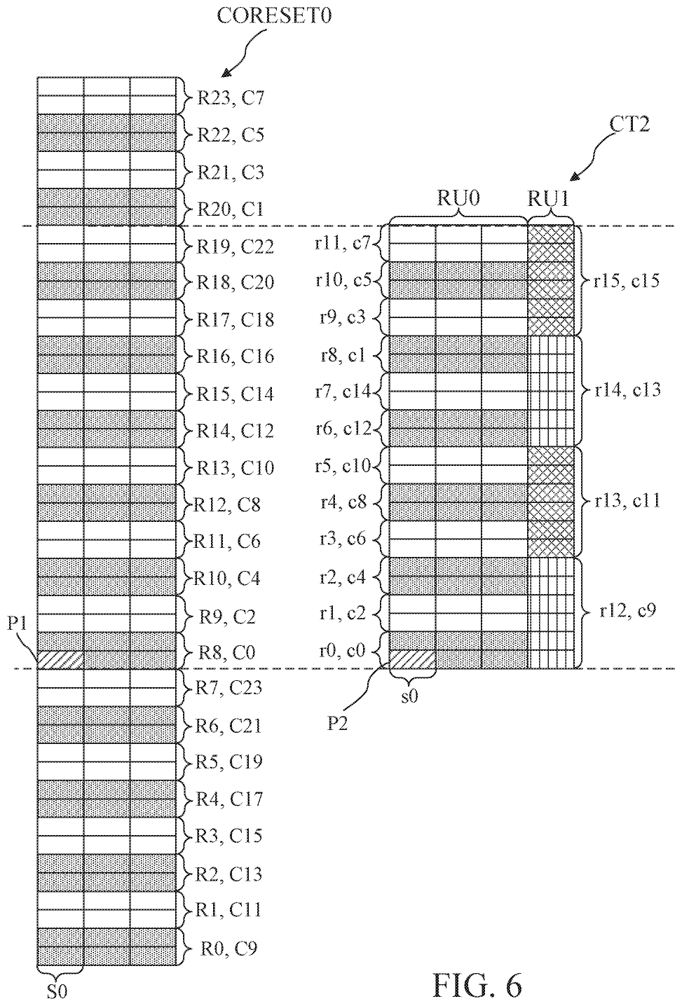

Please refer to FIG. 6 for some implementations of determining the second CORESET CT2 based on the first CORESET CT1 including the CORESET0. In detail, after UE 101 receives MIB information including a configuration of the CORESET0 from BS 102, UE 101 can retrieve the following information from the configuration: (1) the frequency domain size of the CORESET0 includes 48 PRBs; and (2) the time domain size of the CORESET0 includes 3 OFDM symbols. Then, UE 101/BS 102 respectively determines the second CORESET CT2 according to: (1) the configuration of CORESET0; (2) a pre-defined frequency domain size, which includes 24 PRBs, of the second CORESET CT2; and (3) a pre-defined time domain size, which includes 4 OFDM symbols of 2 resource units, of the second CORESET CT2.

Particularly, as for the CORESET0 of these implementations, n_{shift} is configured as 8, N_{REG}^{CORESET} is configured as 48*3=144 and L is configured as 6, i.e., one REGB contains 6 REGs. Therefore, CCE0 of the CORESET0 maps to REGB8. Accordingly, the mapping relation of CCE-to-REG of the CORESET0 is defined as:
CCE0 (C0 as shown in FIG. 6) maps to REGB8 (R8 as shown in FIG. 6)
CCE2 (C2 as shown in FIG. 6) maps to REGB9 (R9 as shown in FIG. 6)
CCE4 (C4 as shown in FIG. 6) maps to REGB10 (R10 as shown in FIG. 6)
CCE6 (C6 as shown in FIG. 6) maps to REGB11 (R11 as shown in FIG. 6)
CCE8 (C8 as shown in FIG. 6) maps to REGB12 (R12 as shown in FIG. 6)
CCE10 (C10 as shown in FIG. 6) maps to REGB13 (R13 as shown in FIG. 6)
CCE12 (C12 as shown in FIG. 6) maps to REGB14 (R14 as shown in FIG. 6)
CCE14 (C14 as shown in FIG. 6) maps to REGB15 (R15 as shown in FIG. 6)
CCE16 (C16 as shown in FIG. 6) maps to REGB16 (R16 as shown in FIG. 6)
CCE18 (C18 as shown in FIG. 6) maps to REGB17 (R17 as shown in FIG. 6)
CCE20 (C20 as shown in FIG. 6) maps to REGB18 (R18 as shown in FIG. 6)
CCE22 (C22 as shown in FIG. 6) maps to REGB19 (R19 as shown in FIG. 6)
CCE1 (C1 as shown in FIG. 6) maps to REGB20 (R20 as shown in FIG. 6)
CCE3 (C3 as shown in FIG. 6) maps to REGB21 (R21 as shown in FIG. 6)
CCE5 (C5 as shown in FIG. 6) maps to REGB22 (R22 as shown in FIG. 6)
CCE7 (C7 as shown in FIG. 6) maps to REGB23 (R23 as shown in FIG. 6)
CCE9 (C9 as shown in FIG. 6) maps to REGB0 (R0 as shown in FIG. 6)
CCE11 (C11 as shown in FIG. 6) maps to REGB1 (R1 as shown in FIG. 6)
CCE13 (C13 as shown in FIG. 6) maps to REGB2 (R2 as shown in FIG. 6)
CCE15 (C15 as shown in FIG. 6) maps to REGB3 (R3 as shown in FIG. 6)
CCE17 (C17 as shown in FIG. 6) maps to REGB4 (R4 as shown in FIG. 6)
CCE19 (C19 as shown in FIG. 6) maps to REGB5 (R5 as shown in FIG. 6)
CCE21 (C21 as shown in FIG. 6) maps to REGB6 (R6 as shown in FIG. 6)
CCE23 (C23 as shown in FIG. 6) maps to REGB7 (R7 as shown in FIG. 6)

Accordingly, as for the second CORESET CT2: (1) in time domain, UE 101 determines that a first OFDM symbol s0 of the second CORESET CT2 starts from a first OFDM symbol S0 of the CORESET0; and (2) in frequency domain, because frequency band of the second CORESET CT2 is within frequency band of the CORESET0 when the initial PRB P2 of the second CORESET CT2 is allocated as an initial PRB P1 of CCE0 of the CORESET0, UE 101/BS 102 determines that the initial PRB P2 of the second CORESET CT2 is allocated as the initial PRB P1 of CCE0 of the CORESET0.

Further, the second CORESET CT2 includes two resource units RU0 and RU1. The number of OFDM symbols of the first resource unit RU0 is the same as the number of OFDM symbols of the CORESET0, which is 3 in these implementations. The first resource unit RU0 includes 12 REGBs. The number of OFDM symbols of the second resource unit RU1 is 1 in these implementations. The second resource unit RU1 includes 4 REGBs. Therefore, resource units RU0 and RU1 include 16 REGBs. The REGBs of the second CORESET CT2 are: (1) sequentially indexed in each resource unit; and (2) sequentially indexed from one resource unit to another resource unit. Accordingly, 16 REGBs are indexed as REGB0 to REGB15 (r0 to r15 as shown in FIG. 6).

Next, because the initial PRB P2 of the second CORESET CT2 is allocated as the initial PRB P1 of CCE0 of the CORESET0, n_{shift} is configured as 0. Therefore, a mapping relation of CCE-to-REG of the second CORESET CT2 is defined as:
CCE0 (c0 as shown in FIG. 6) maps to REGB0 (r0 as shown in FIG. 6)
CCE2 (c2 as shown in FIG. 6) maps to REGB1 (r1 as shown in FIG. 6)
CCE4 (c4 as shown in FIG. 6) maps to REGB2 (r2 as shown in FIG. 6)
CCE6 (c6 as shown in FIG. 6) maps to REGB3 (r3 as shown in FIG. 6)
CCE8 (c8 as shown in FIG. 6) maps to REGB4 (r4 as shown in FIG. 6)
CCE10 (c10 as shown in FIG. 6) maps to REGB5 (r5 as shown in FIG. 6)
CCE12 (c12 as shown in FIG. 6) maps to REGB6 (r6 as shown in FIG. 6)
CCE14 (c14 as shown in FIG. 6) maps to REGB7 (r7 as shown in FIG. 6)
CCE1 (c1 as shown in FIG. 6) maps to REGB8 (r8 as shown in FIG. 6)
CCE3 (c3 as shown in FIG. 6) maps to REGB9 (r9 as shown in FIG. 6)
CCE5 (c5 as shown in FIG. 6) maps to REGB10 (r10 as shown in FIG. 6)
CCE7 (c7 as shown in FIG. 6) maps to REGB11 (r11 as shown in FIG. 6)
CCE9 (c9 as shown in FIG. 6) maps to REGB12 (r12 as shown in FIG. 6)
CCE11 (c11 as shown in FIG. 6) maps to REGB13 (r13 as shown in FIG. 6)
CCE13 (c13 as shown in FIG. 6) maps to REGB14 (r14 as shown in FIG. 6)
CCE15 (c15 as shown in FIG. 6) maps to REGB15 (r15 as shown in FIG. 6)

In these implementations, a first search space set corresponding to a first set of aggregation levels is designated to the CORESET0. In detail, because the CORESET0 includes 24 REGBs, the first aggregation level supports aggregation level 16 at most (i.e., the first aggregation level supports aggregation level 4, 8 and 16). Accordingly, since the aggregation levels of a second aggregation level should be equal to or higher than those in the first aggregation level set, UE 101 determines the maximum aggregation level as 16 for a second search space set of the second CORESET CT2. The CCE indices for each candidate of each aggregation level of the second aggregation level are listed in the following table:

| | CCE indices | CCE indices | CCE indices | CCE indices |
|---|---|---|---|---|
| Aggregation | of 1^{st} | of 2^{nd} | of 3^{rd} | of 4^{th} |
| Level | candidate | candidate | candidate | candidate |
| 4 | 0, 1, 2, | 4, 5, 6, | 8, 9, 10, | 12, 13, 14, |
| | 3 | 7 | 11 | 15 |
| 8 | 0, 1, 2, | 8, 9, 10, | null | null |
| | 3, 4, 5, | 11, 12, 13, | | |
| | 6, 7 | 14, 15 | | |
| 16 | 0, 1, 2, | null | null | null |
| | 3, 4, 5, | | | |
| | 6, 7, 8, | | | |
| | 9, 10, 11, | | | |
| | 12, 13, 14, 15 | | | |

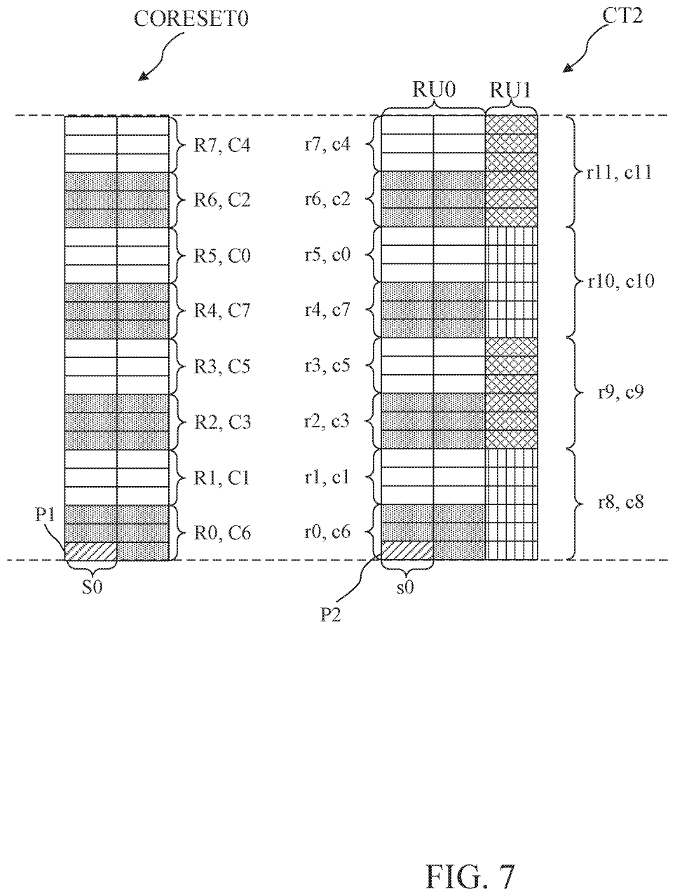

Please refer to FIG. 7 for some implementations of determining the second CORESET CT2 based on the first CORESET CT1 including the CORESET0. In detail, after UE 101 receives MIB information including a configuration of the CORESET0 from BS 102, UE 101 can retrieve the following information from the configuration: (1) the frequency domain size of the CORESET0 includes 24 PRBs; and (2) the time domain size of the CORESET0 includes 2 OFDM symbols. Then, UE 101/BS 102 respectively determines the second CORESET CT2 according to: (1) the configuration of CORESET0; (2) a pre-defined frequency domain size, which includes 24 PRBs, of the second CORESET CT2; and (3) a pre-defined time domain size, which includes 3 OFDM symbols of 2 resource units, of the second CORESET CT2.

Particularly, as for the CORESET0 of these implementations, n_{shift} is configured as 5, N_{REG}^{CORESET} is configured as 24*2=48 and L is configured as 6. Therefore, CCE0 of the CORESET0 maps to REGB5. Further, the mapping relation of CCE-to-REG of the CORESET0 is defined as:
CCE0 (C0 as shown in FIG. 6) maps to REGB5 (R5 as shown in FIG. 6)
CCE2 (C2 as shown in FIG. 6) maps to REGB6 (R6 as shown in FIG. 6)
CCE4 (C4 as shown in FIG. 6) maps to REGB7 (R7 as shown in FIG. 6)
CCE6 (C6 as shown in FIG. 6) maps to REGB0 (R0 as shown in FIG. 6)
CCE1 (C1 as shown in FIG. 6) maps to REGB1 (R1 as shown in FIG. 6)
CCE3 (C3 as shown in FIG. 6) maps to REGB2 (R2 as shown in FIG. 6)
CCE5 (C5 as shown in FIG. 6) maps to REGB3 (R3 as shown in FIG. 6)
CCE7 (C7 as shown in FIG. 6) maps to REGB4 (R4 as shown in FIG. 6)

Accordingly, as for the second CORESET CT2: (1) in time domain, UE 101 determines that a first OFDM symbol s0 of the second CORESET CT2 starts from a first OFDM symbol S0 of the CORESET0; and (2) in frequency domain, because frequency band of the second CORESET CT2 is equal to frequency band of the CORESET0 when the initial PRB P2 of the second CORESET CT2 is allocated as an initial PRB P1 of CCE0 of the CORESET0, UE 101 determines that the initial PRB P2 of the second CORESET CT2 is allocated as the initial PRB P1 of CCE0 of the CORESET0.

In some implementations, when frequency band of the second CORESET CT2 is equal to frequency band of the CORESET0, a mapping relation of CCE-to-REG of the second CORESET CT2 in a first resource unit RU0 is the same as the mapping relation of CCE-to-REG of the CORESET0, which is as following:
CCE0 (c0 as shown in FIG. 6) maps to REGB5 (r5 as shown in FIG. 6)
CCE2 (c2 as shown in FIG. 6) maps to REGB6 (r6 as shown in FIG. 6)
CCE4 (c4 as shown in FIG. 6) maps to REGB7 (r7 as shown in FIG. 6)
CCE6 (c6 as shown in FIG. 6) maps to REGB0 (r0 as shown in FIG. 6)
CCE1 (c1 as shown in FIG. 6) maps to REGB1 (r1 as shown in FIG. 6)
CCE3 (c3 as shown in FIG. 6) maps to REGB2 (r2 as shown in FIG. 6)
CCE5 (c5 as shown in FIG. 6) maps to REGB3 (r3 as shown in FIG. 6)
CCE7 (c7 as shown in FIG. 6) maps to REGB4 (r4 as shown in FIG. 6)

In some implementations, CCEs and REGBs in a second resource unit RU1 are sequentially indexed and a mapping relation of CCE-to-REG of the second CORESET CT2 in the second resource unit RU1 is defined as following:
CCE8 (c8 as shown in FIG. 6) maps to REGB8 (r9 as shown in FIG. 6)
CCE9 (c9 as shown in FIG. 6) maps to REGB9 (r9 as shown in FIG. 6)
CCE10 (c10 as shown in FIG. 6) maps to REGB10 (r10 as shown in FIG. 6)
CCE11 (c11 as shown in FIG. 6) maps to REGB11 (r11 as shown in FIG. 6)

In these implementations, a first search space set corresponding to a first set of aggregation levels is designated to the CORESET0. In detail, because the CORESET0 includes 8 REGBs, the first aggregation level set supports aggregation level 8 at most (i.e., the first aggregation level supports aggregation level 4 and 8). Accordingly, since the aggregation levels in a second aggregation level should be equal to or higher than those in the first aggregation level set, UE 101 determines the maximum aggregation level as 8 for a second search space set of the second CORESET CT2. The CCE indices for each candidate of each aggregation level of the second aggregation level are listed in the following table:

| | CCE indices | CCE indices | CCE indices | CCE indices |
|---|---|---|---|---|
| Aggregation | of 1^{st} | of 2^{nd} | of 3^{rd} | of 4^{th} |
| Level | candidate | candidate | candidate | candidate |
| 4 | 0, 1, 2, | 4, 5, 6, | null | null |
| | 3 | 7 | | |
| 8 | 0, 1, 2, | null | null | null |
| | 3, 4, 5, | | | |
| | 6, 7 | | | |

In some implementations, because the number (i.e., 12) of CCEs of the second CORESET CT2 is greater than 8, another aggregation level may be introduced as following:

| | CCE indices | CCE indices | CCE indices | CCE indices |
|---|---|---|---|---|
| Aggregation | of 1^{st} | of 2^{nd} | of 3^{rd} | of 4^{th} |
| Level | candidate | candidate | candidate | candidate |
| 4 | 0, 1, 2, | 4, 5, 6, | null | null |
| | 3 | 7 | | |
| 8 | 0, 1, 2, | null | null | null |
| | 3, 4, 5, | | | |
| | 6, 7 | | | |
| 12 | 0, 1, 2, | null | null | null |
| | 3, 4, 5, | | | |
| | 6, 7, 8, | | | |
| | 9, 10, 11 | | | |

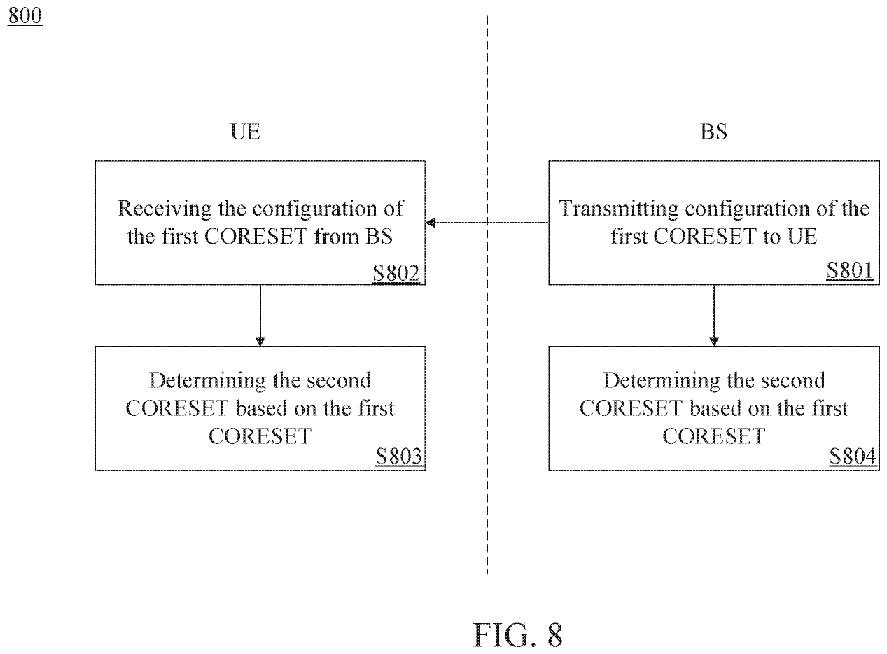

FIG. 8 illustrates a flow chart of a method for wireless communications in accordance with some embodiments of the present application. Referring to FIG. 8, method 800 is performed by a UE (e.g., UE 101) and a BS (e.g., BS 102) in some embodiments of the present application.

Operation S801 is executed to transmit, by BS, configuration of a first CORESET to UE. Operation S802 is executed to receive, by UE the configuration information from BS. Operations S803 and S804 are executed to determine, by UE and BS respectively, a second CORESET based on the first CORESET. In some embodiments, an initial PRB of the second CORESET may be allocated as an initial PRB of a specific CCE of the first CORESET. It should be noted that BS 102 may execute operation S804 after executing S801.

In some embodiments, the initial PRB of the second CORESET may be allocated as the initial PRB of the specific CCE of the first CORESET when a frequency band of the second CORESET is within a frequency band of the first CORESET.

In some implementations, the first CORESET may include a CORESET0 and the specific CCE of the first CORESET include an initial CCE of the CORESET0 (i.e., CCE0 of CORESET0). In the second CORESET, an initial CCE of the second CORESET is mapped to an initial REGB of the second CORESET.

In some embodiments, the CCEs of the second CORESET may be mapped to the CCEs of the first CORESET. The mapping could be either 1-to-1 mapping or many-to-one mapping.

In some implementations, the first CORESET may include the CORESET0 and the specific CCE of the first CORESET may have a CCE offset from the initial CCE of the CORESET0. In these implementations, the CCE offset is 1 and the specific CCE is CCE1. In the second CORESET, an initial CCE of the second CORESET is mapped to an REGB of the second CORESET and the index of the initial CCE maps to an index of the REGB based on the following formula:
REGBindex=(N_RegBundle/2) mod (N_{REG}^{CORESET}/L)
   wherein REGBindex represents the index of the REGB, N_RegBundle represents a number of REGBs of the first CORESET, N_{REG}^{CORESET} represents a number of REGs of the first CORESET and L represents a number of REGs in one REGB.

In some implementations, the initial PRB of the second CORESET may be allocated as the initial PRB of an REGB of the first CORESET. In detail, the initial PRB of the second CORESET may be allocated as the initial PRB of the REGB of the first CORESET when a frequency band of the second CORESET is within a frequency band of the first CORESET. In these implementations, the first CORESET may include a CORESET0 and the REGB may include an initial REG of the CORESET0 (i.e., REGB0 of CORESET0).

In some implementations, the second CORESET may include at least one resource unit defined in time domain. In detail, a time duration (i.e., OFDM symbols) of one of the at least one resource unit may the same as a time duration (i.e., OFDM symbols) of the first CORESET. The second CORESET may include a plurality of REGBs, and the REGBs are sequentially indexed in the at least one resource unit. In addition, a first REGB of the REGBs of the second CORESET may include same number of REGs as an REGB in the first CORESET in time domain and in frequency domain respectively.

Further, the at least one resource unit includes a first resource unit and a mapping relation of CCE-to-REG of the first resource unit of the second CORESET may be the same as a mapping relation of CCE-to-REG of the first CORESET. The at least one resource unit may include a second resource unit and a mapping relation of CCE-to-REGB of the second resource unit of the second CORESET is with same index.

In some implementations, BS may transmit the configuration of the first CORESET further with a first search space set. The first search space set corresponds to a first aggregation level. For example, when the first CORESET includes the CORESET0, the configuration of the first CORESET may include search space zero and the first aggregation level may include aggregation level 4, 8 and 16 which correspond to number of CCE candidates 4, 2 and 1 respectively. Next, UE may receive the configuration of the first CORESET and the first search space set. UE/BS may determine a second aggregation level for a second search space set of the second CORESET. In these implementations, the second aggregation level may be equal to or higher than the first aggregation level.

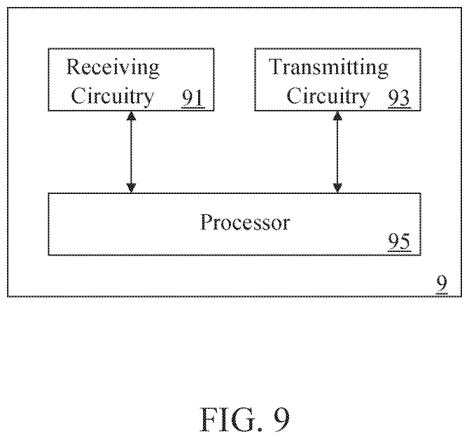

FIG. 9 illustrates an example block diagram of an apparatus 9 according to an embodiment of the present disclosure.

As shown in FIG. 9, the apparatus 9 may include at least one non-transitory computer-readable medium (not illustrated in FIG. 9), a receiving circuitry 91, a transmitting circuitry 93, and a processor 95 coupled to the non-transitory computer-readable medium (not illustrated in FIG. 9), the receiving circuitry 91 and the transmitting circuitry 93. The apparatus 9 may be a user equipment or a base station.

Although in this figure, elements such as processor 95, transmitting circuitry 93, and receiving circuitry 91 are described in the singular, the plural is contemplated unless limitation to the singular is explicitly stated. In some embodiments of the present disclosure, the receiving circuitry 91 and the transmitting circuitry 93 are combined into a single device, such as a transceiver. In certain embodiments of the present disclosure, the apparatus 9 may further include an input device, a memory, and/or other components.

In some embodiments of the present disclosure, the non-transitory computer-readable medium may have stored thereon computer-executable instructions to cause a processor to implement the method with respect to the base station as described above. For example, the computer-executable instructions, when executed, cause the processor 95 interacting with receiving circuitry 91 and transmitting circuitry 93, so as to perform the operations with respect to BS depicted in FIGS. 1 to 2A.

In some embodiments of the present disclosure, the non-transitory computer-readable medium may have stored thereon computer-executable instructions to cause a processor to implement the method with respect to the user equipment as described above. For example, the computer-executable instructions, when executed, cause the processor 9 interacting with receiving circuitry 91 and transmitting circuitry 93, so as to perform the operations with respect to UE depicted in FIGS. 1 to 2A.

Those having ordinary skill in the art would understand that the operations of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes”, “including”, or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a”, “an”, or the like does not, without more constraints, preclude the existence of additional identical elements in the process, method, article, or apparatus that includes the element. Also, the term “another” is defined as at least a second or more. The term “having” and the like, as used herein, are defined as “including”.

1. A method, comprising:
receiving a configuration of a first control resource set (CORESET) from a base station; and
determining a second CORESET based at least in part on the first CORESET, an initial physical resource block (PRB) of the second CORESET is allocated as an initial PRB of a control channel element (CCE) of the first CORESET.

2. The method of claim 1, wherein the initial PRB of the second CORESET is allocated as the initial PRB of the CCE of the first CORESET and a frequency band of the second CORESET is within a frequency band of the first CORESET.

3. The method of claim 2, wherein the first CORESET includes a CORESET zero (CORESET0) and the CCE of the first CORESET includes an initial CCE of the CORESET0.

4. The method of claim 3, wherein an initial CCE of the second CORESET is mapped to an initial resource element group bundle (REGB) of the second CORESET.

5. The method of claim 2, wherein the first CORESET includes a CORESET zero (CORESET0) and the CCE of the first CORESET has a CCE offset from an initial CCE of the CORESET0.

6. The method of claim 5, wherein the CCE offset is 1 and an index of the CCE is 1.

7. (canceled)

8. The method of claim 1, wherein the initial PRB of the second CORESET is allocated as the initial PRB of a resource element group bundle (REGB) of the first CORESET.

9. The method of claim 8, wherein the initial PRB of the second CORESET is allocated as the initial PRB of the REGB of the first CORESET if a frequency band of the second CORESET is within a frequency band of the first CORESET.

10. (canceled)

11. The method of claim 1, wherein the second CORESET starts from the first OFDM symbol of the first CORESET.

12. The method of claim 1, wherein the second CORESET includes at least one resource unit defined in time domain.

13-17. (canceled)

18. The method of claim 1, wherein:
receiving the configuration further comprises receiving the configuration of the first CORESET and a first search space set corresponding to a first aggregation level; and
the method further comprises determining a second aggregation level for a second search space of the second CORESET, wherein the second aggregation level is equal to or higher than the first aggregation level.

19-36. (canceled)

37. An apparatus, comprising:
a receiving circuitry;
a transmitting circuitry; and
a processor coupled to the receiving circuitry and the transmitting circuitry configured to:
receive a configuration of a first control resource set (CORESET) from a base station; and
determine a second CORESET based at least in part on the first CORESET, an initial physical resource block (PRB) of the second CORESET being allocated as an initial PRB of a control channel element (CCE) of the first CORESET.

38. The apparatus of claim 37, wherein the initial PRB of the second CORESET is allocated as the initial PRB of the CCE of the first CORESET and a frequency band of the second CORESET is within a frequency band of the first CORESET.

39. The apparatus of claim 38, wherein the first CORESET includes a CORESET zero (CORESET0) and the CCE of the first CORESET includes an initial CCE of the CORESET0.

40. The apparatus of claim 39, wherein an initial CCE of the second CORESET is mapped to an initial resource element group bundle (REGB) of the second CORESET.

41. The apparatus of claim 38, wherein the first CORESET includes a CORESET zero (CORESET0) and the CCE of the first CORESET has a CCE offset from an initial CCE of the CORESET0.

42. The apparatus of claim 41, wherein the CCE offset is 1 and an index of the CCE is 1.

43. An apparatus, comprising:
a receiving circuitry;
a transmitting circuitry; and
a processor coupled to the receiving circuitry and the transmitting circuitry configured to:
transmit a configuration of a first control resource set (CORESET) to a user equipment (UE);
determine, based at least in part on the first control resource set (CORESET), a second CORESET, wherein an initial physical resource block (PRB) of the second CORESET is allocated as an initial PRB of a control channel element (CCE) of the first CORESET.

44. The apparatus of claim 43, wherein the initial PRB of the second CORESET is allocated as the initial PRB of the CCE of the first CORESET and a frequency band of the second CORESET is within a frequency band of the first CORESET.

45. The apparatus of claim 44, wherein:
the first CORESET includes a CORESET zero (CORESET0) and the CCE of the first CORESET includes an initial CCE of the CORESET0; and
an initial CCE of the second CORESET is mapped to an initial resource element group bundle (REGB) of the second CORESET.
